(19) United States
(12) Patent Application Publication
(10) Pub. No.: US 2026/0139824 A1
(43) Pub. Date: May 21, 2026

(54) SPEAKER WITH ILLUMINATED DIAPHRAGM

(71) Applicant: HARMAN BECKER AUTOMOTIVE SYSTEMS, INC., Novi, MI (US)

(72) Inventor: Henrik Kirkeby JEPSEN, Vinderup (DK)

(73) Assignee: HARMAN BECKER AUTOMOTIVE SYSTEMS, INC., Novi, MI (US)

(21) Appl. No.: 19/335,731

(22) Filed: Sep. 22, 2025

(30) Foreign Application Priority Data
Nov. 19, 2024 (EP) 24213798.2

(51) Int. Cl. F21V 33/00; H04R 7/12; H04R 9/02; H04R 9/06

(52) U.S. Cl. CPC F21V 33/0056; H04R 7/12; H04R 9/025; H04R 9/06

(57) ABSTRACT

The application relates to speaker configured to emit sound in a main sound emission direction, the speaker comprising a movable diaphragm; a drive unit comprising a magnet generating a magnetic field, a first pole piece comprising a through hole arranged to contact the magnet on a first surface of the magnet, a second pole piece arranged to contact the magnet on a second surface of the magnet opposite the first surface, wherein the first and second pole pieces are configured to generate a magnetic field in an air gap between the first and second pole piece where the diaphragm is located. The speaker includes a light source configured to emit light and a light guide configured to guide the light emitted by the light source through the through hole in direction of the main sound emission direction to the movable diaphragm.

### CROSS-REFERENCE TO RELATED APPLICATIONS

This application claims priority to EP Application No. EP 24 213 798.2 filed November 19, 2024, the disclosure of which is hereby incorporated in its entirety by reference herein.

### TECHNICAL FIELD

The present application relates to a speaker, and more particular to a speaker configured to emit light.

### BACKGROUND

Audio speakers (also referred to as loudspeakers, audio loudspeakers, or simply speakers) may involve the use of movable diaphragms driven by voice coils to generate and emit acoustic sound waves. This technology has been widely adopted in various applications, including home entertainment systems, public address systems, and vehicle audio systems. However, with the increasing demand for visually appealing audio devices, there is a growing need to integrate lighting into audio speakers without compromising their performance or increasing their size.

Despite these challenges, various solutions have been proposed to address the need for illuminated audio speakers. One such solution involves the use of light guides to distribute light from a remote light source to the speaker, for example illuminating the diaphragm. However, this approach may raise several problems. For instance, light guides can be a source of rattling sounds, which can negatively impact the overall acoustic performance of the speaker. Additionally, light guides can increase the cost and complexity of assembling and disassembling the speaker. Furthermore, it has to be made sure that the light source is located at a position where a heating of the light source is avoided as the repeated heating of the light source used for illuminating the speaker would decrease the lifetime of the light source.

Accordingly, a need exists to provide a cost-effective way to use a light guide in different magnet assemblies, ensuring that acoustic performance is not negatively impacted, no rattling sounds are created, and the lifetime of the light source is not affected by operating the speaker. The aim is to design an easy-to-mount fixation option that does not limit the light guide's efficiency or its ability to effectively mix colors, while also being sustainable and easily disassembled, thereby overcoming the above-mentioned problems at least in part.

### SUMMARY

This need is met by the feature of the independent claim. Further aspects are described in the dependent claims.

One aspect of the present disclosure relates to a speaker configured to emit sound in a main sound emission direction wherein the speaker comprises a diaphragm, a drive unit including a magnet generating a magnetic field, a first pole piece comprising a through hole arranged to contact the magnet on a first surface of the magnet, and a second pole piece arranged to contact the magnet on a second surface of the magnet opposite the first surface. The first and second pole pieces are configured to generate a magnetic field in an air gap between the first and second pole piece, where the diaphragm is located. The speaker furthermore comprises a light source configured to emit light. The speaker includes a light guide configured to guide the light emitted by the light source through the through hole in direction of the main sound emission direction to the movable diaphragm. The light guide comprises an elongated first section with a longitudinal axis parallel to the main sound emission direction and comprises a second section extending substantially perpendicular to the elongated first section wherein the light guide is configured to guide the light through the elongated first section to the second section where the light is guided in direction of the movable diaphragm. The elongated first section comprises a first connecting element and a second connecting element to provide an interference fit between the light guide and the first pole piece.

An effect of the speaker is that the light guide can be mounted to the first pole piece in an effective way and this interference fit is only obtained by the elongated first section and the first connecting element and the second connecting element connecting to the first pole piece without affecting the performance of the magnet and thus the performance of the speaker. No additional fixation means such as screws or adhesives are used allowing an easy assembly and disassembly and an exact positioning of the light guide relative to the drive unit, here the first pole piece.

Furthermore the light source is positioned at a position within the speaker where it is not heated by heat generated by the voice coil as the light guide helps to increase the distance between the voice coil and the light source as the light guide guides the light through the through hole of the drive unit in direction of the movable diaphragm. Thus, it is possible to arrange the light source on one side of the drive unit and the coil contained in the magnetic field on the other side of the drive unit.

It is to be understood that the features mentioned above and features yet to be explained below can be used not only in the respective combinations indicated, but also in other combinations or in isolation without departing from the scope of the present disclosure. Features of the above-mentioned aspects and embodiments described below may be combined with each other in other embodiments unless explicitly mentioned otherwise.

### BRIEF DESCRIPTION OF THE DRAWINGS

Other devices, systems, methods, features and advantages of the disclosure will be or will become apparent to those skilled in the art upon examination of the following detailed description and figures. In particular, the features and effects of the application will become apparent from the following detailed description when read in conjunction with the accompanying drawings, in which like reference numerals refer to like elements.

FIG. 1 shows a schematic cross-sectional view of an audio speaker which is illuminated by a light source incorporating features of the disclosure.

FIG. 2 shows a more detailed view of a section highlighted in FIG. 1.

FIG. 3 shows another more detailed view of a section highlighted in FIG. 1.

FIG. 4 shows yet another more detailed view of a section highlighted in FIG. 1.

FIG. 5 shows a schematic exploded view of the audio speaker illuminated with a light source shown in FIG. 1.

FIG. 6 shows a schematic cross-sectional view of the light guide and the light path within the light guide.

FIG. 7 shows a schematic top view of the light guide.

FIG. 8 shows a sectional view of the light guide across a cross-section A-A shown in FIG. 7 and further details of connecting elements at the light guide used to obtain an interference fit with one of the pole pieces.

FIG. 9 shows another schematic cross-sectional view of an audio speaker which is illuminated by a light source incorporating features of the disclosure.

### DETAILED DESCRIPTION

In the following, embodiments of the disclosure will be described in detail with reference to the accompanying drawings. It is to be understood that the following description of embodiments is not to be taken in a limiting sense. The scope of the disclosure is not intended to be limited by the embodiments described below or by the drawings, which are for illustrative purposes only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling.

In the present context the terms ‘audio speaker’ should be interpreted to mean a device that is capable of generating and emitting acoustic waves by actuating a movable diaphragm into a main sound emission direction. Thus, the audio speaker according to the present disclosure includes a movable diaphragm and a drive, e.g. a voice coil, arranged to actuate the movable diaphragm. During operation of the audio speaker, voice coil receives appropriate input signals and operates in response to the received input signals in such a manner that it causes the movable diaphragm to move or vibrate and thereby generate acoustic waves in accordance with the input signals.

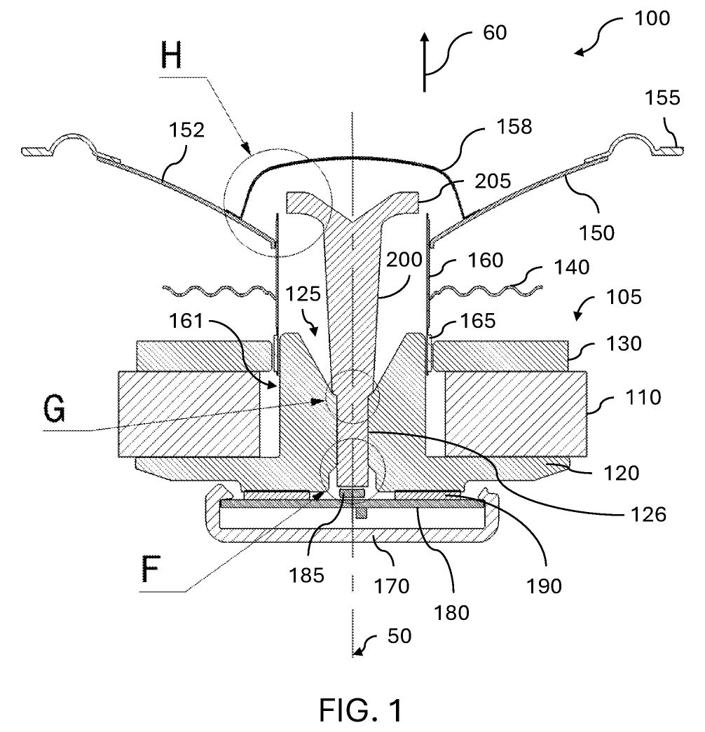

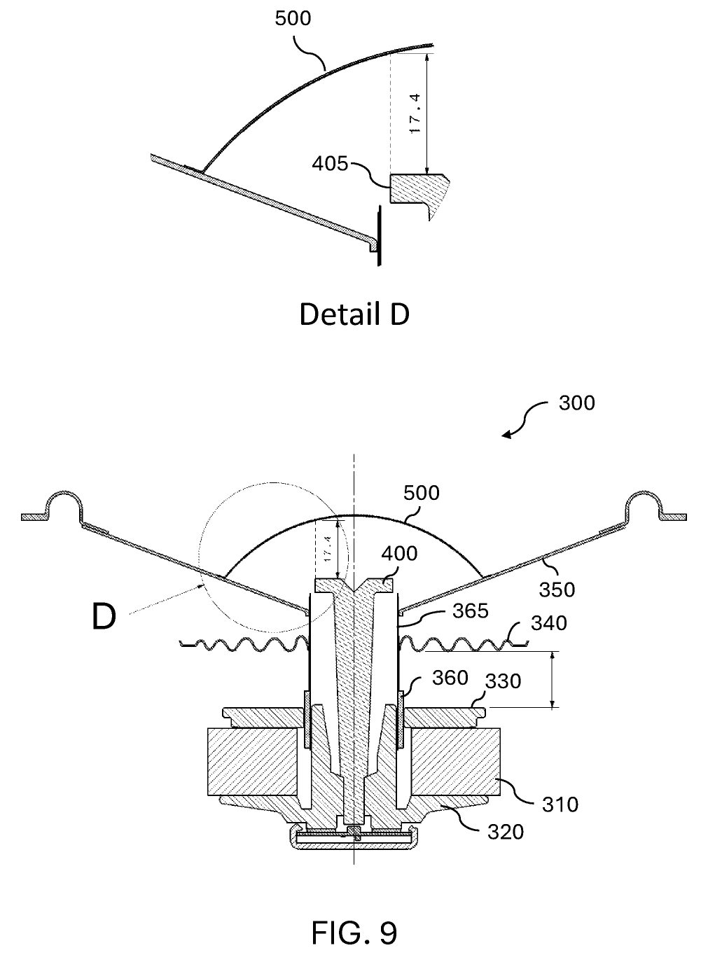

Referring to FIG. 1 an audio speaker 100 is shown which includes at drive unit 105, a diaphragm 150, a protective cap 158 also referred to as dust cap connected to the diaphragm 150. The drive unit 105 comprises a magnet 110, a first pole piece 120 and a second pole piece 130. A magnetic field generated by the magnet is aligned through the pole pieces 120 and 130 in an air gap 161 so that a substantially homogenic magnetic the field is generated in the air gap 161. A voice coil 165 is arranged in the air gap so that changes in the varying magnetic field induced by the voice coil when a varying current is applied to the windings of the voice coil 165 causes the voice coil to move in an axial direction, parallel to a main sound emission direction 60 shown in FIG. 1. The voice coil 165 is connected to the movable diaphragm 150 with a support 160 so that the diaphragm is arranged to move together with the voice coil in order to generate and emit acoustic waves from the speaker 100 wherein the acoustic waves or sound is emitted in the main sound emission direction 60 in FIG. 1. The main sound emission direction is thus parallel to a central axis 50 of the speaker and is directed away from the loudspeaker 100. The movement of the voice coil is guided by a spider 140. The diaphragm 150 is furthermore connected to a frame 155 of the speaker 100. In the embodiment shown the speaker is a mid-range speaker emitting sound waves in the frequency range between app. 200 and approximately 5000 Hz. However, it should be understood that the technology discussed above and below can also be applied in any other frequency range, be it a woofer as explained later in connection with FIG. 9, or be it a tweeter.

The speaker furthermore comprises a circuit board 180 comprising at least one light source 185. The circuit board 180 is connected to one of the pole pieces, here the first pole piece 120 where a fixing element 190 which can be implemented as a tape or any other element by which the circuit board can be attached to the lower side of the drive unit 105. A closing element 170 such as a bracket forms an end surface at the lower side of the speaker 100. In the present context lower surface or side and upper surface inside is considered relative to the sound emission direction 60 wherein the upper or front side is the side of the speaker 100 visible to the user and where the sound waves are emitted in direction of the main sound emission direction, wherein the lower side is the opposite or rear side of the speaker 100. The light generated by the light source 185 is guided through a light guide 200 and the light exits the light guide at a light exit 205.

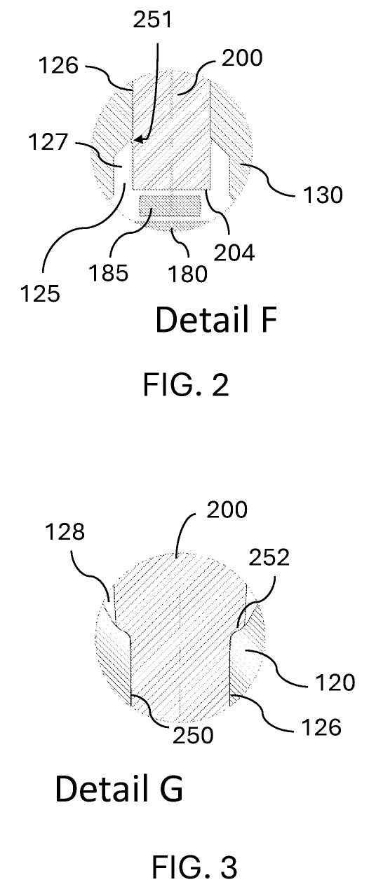

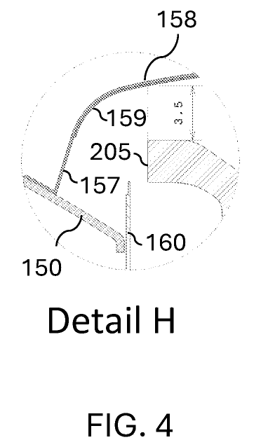

Referring also to FIGS. 2 and 4 the light emitted by light source 185 enters the light guide 200 through a light receiving surface 204 and is guided through the light guide 200 substantially parallel to the main sound emission direction before it is deviated to exit the light guide at the light exit 205.

Making reference especially to FIG. 4 the light leaving the light guide at exit surface passes through a transparent side surface 157 of the cap 158 whereas the remaining part of the cap is covered with a non-transparent material 159. The cap moves together with the diaphragm relative to the light guide and therefore relative to the light exit 205. As the transparent side surface 157 moves relative to the light guide an opening window is defined which provides a part of the transparent side surface through which light emitted from the light guide can directly hit a front surface 152 of the diaphragm 150. The size of this opening window changes together with the movement of the diaphragm and also depends on a position of a lower edge of the non-transparent material 159 relative to the position of the light exit 205. Furthermore, as can be seen in FIG. 4 the air can move freely from the top of the light guide to under the light guide while the diaphragm 150 and the cap 158 move.

In the present context, the term light source should be interpreted to mean a device which is configured to generate light, i.e. electromagnetic waves, preferably within a wavelength range visible to a human eye. However, it is not ruled out that the light source is capable of generating light outside the visible range such as infrared, IR, or ultraviolet, UV, light. The light source could be or include one or more Light Emitting Diodes, LEDs, a laser, a Laser Activated Remote Phosphor, LARP, light source or any other suitable kind of light source. The light source can include a combination of white and colored LEDs such as RGB LEDs, a red, a green and a blue LED or white LEDs and the light guide is also operating as a color mixer for the light where the different light colors emitted by the different LEDs are mixed before they exit the light guide.

In the present context, the light guide 200 should be interpreted to mean a component or element that is configured to guide light from one position to another. The light guide could or can include a waveguide, an optical fiber with a core and a cladding layer, one or more reflective elements, and/or any suitable other optical elements. By way of example the light guide 200 can be made of a plastic material such as PMMA, PMMI, or polycarbonate, PC.

As shown in FIG. 1 the light guide 200 is arranged to guide the light emitted from the light source 185 to the front surface 152 of the diaphragm 150, and the light source 185 is positioned a distance away from the diaphragm. The light guide interconnects the light source 185 and the front surface 152 of the diaphragm 150.

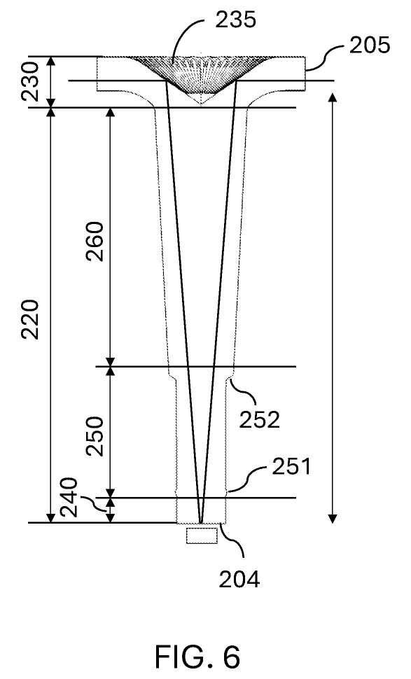

With reference to FIG. 6 the light guide 200 is explained in more detail. The light guide includes an elongated first section 220 with a longitudinal axis parallel to the main sound emission direction 60 and parallel to the main axis of the speaker 100. Furthermore, the light guide comprises a second section 230 where the light is reflected towards the light exit 205. The second section 230 comprises a prism 235 which is provided to change the direction of the light path from a direction substantially parallel to the main sound emission direction to a direction perpendicular to the main sound emission direction or the middle axis 50. The prism 235 has reflecting surfaces configured to obtain the redirection of the light path. The entire light guide can be made of transparent material to light but has internal reflecting surfaces such that a total internal reflection, TIR, is generated in the light guide. All the side surfaces can be implemented as reflecting surfaces reflecting light that hits the surface at an angle smaller than a defined angle such as 20-30 degrees. This helps to make sure that a major part of the light guided through the light guide will exit the light guide at the light exit 205.

The elongated first section 220 comprises an inlet portion 240, followed by a connection portion 250 by which the light guide is connected to the drive unit, here especially the first pole piece 120 as shown in FIG. 1. Following the connection portion 250 the elongated first section 220 comprises a further portion 260 followed by the second section 230 of the light guide where the light is reflected in direction of the light exit 205.

Referring to FIGS. 2, 3, 6 and 8 the connection portion 250 has a cylindrical shape with a constant diameter in the direction perpendicular to the main axis. The connection portion comprises a first connecting element which is implemented as a first protrusion 251 protruding perpendicular to the longitudinal axis of the connection portion from the outer lateral surface of the connection portion 250. The first protrusion provides a support structure for an edge of the through hole 125 provided in the first pole piece 120. The through hole 125 comprises a receiving portion 126 having a cylindrical shape with a constant diameter. The outer diameter of the protrusion of first connecting element 251 is such that it is larger than the inner diameter of the receiving portion 126. The through hole 125 furthermore includes at its lower end facing the light source 185 a V-shape portion 127 which opens in direction of the light source 185. The protrusion 251 can abut against an edge of the through hole 125 at the transition between the V-shaped portion 127 and the receiving portion 126. The light guide furthermore comprises a second protrusion 252 which can abut on a front edge of the through hole 125 an edge where the receiving portion 126 ends and another V-shape portion 128 of the through hole starts. The light guide 200 can be inserted through the V shaped portion 128 and can be pressed through the receiving portion until the first protrusion is located at the edge or transition of the receiving portion and the V shaped portion 127. In general the edge may be understood as a boundary or border between two surfaces. In this context, the edge refers to the transition point where the conical shape meets the cylindrical portion of receiving portion. An interference fit may be understood as a tight fit between two parts, where one part is slightly larger than the other, requiring some force to assemble and disassemble.

An interference fit is obtained by the first protrusion 251 of the light guide 200 cooperating with one end of the receiving portion of the through hole and thus with one part of the first pole piece120. Furthermore the interference fit it is obtained by the second protrusion 252 cooperating with the upper edge of the receiving portion of the through hole. Accordingly the first and second protrusions are the only elements providing the interference fit of the light guide 200 with the first pole piece 120 and especially here the through hole provided in the pole piece.

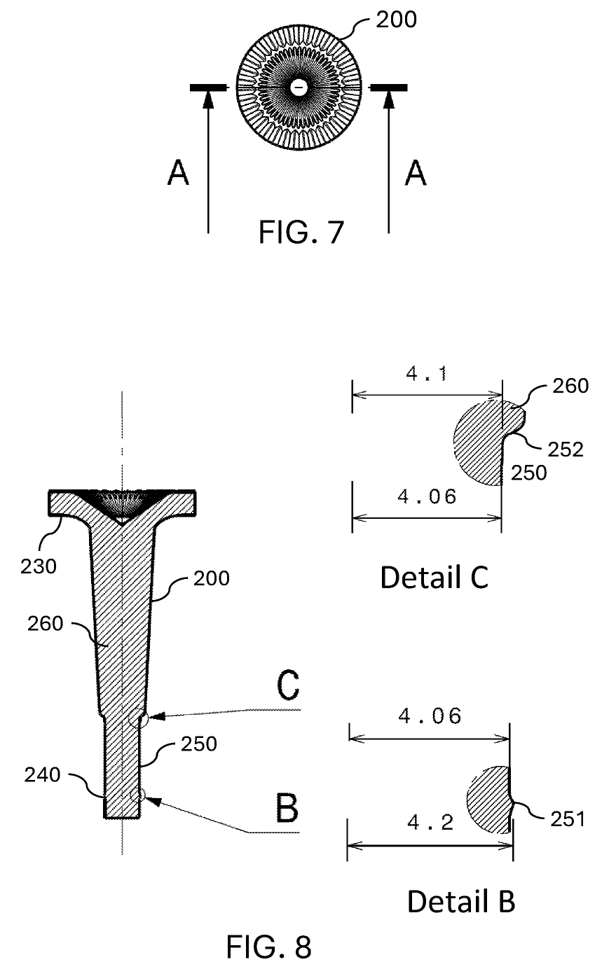

FIG. 7 is a top view of the light guide 200 and FIG. 8 is a sectional view across line A-A of FIG. 7. FIG. 8 furthermore shows the details C and B which show the protrusions 251 and 252 in more detail. The second protrusion 252 is formed by the transition between connection portion 250 and the further portion 260. In the following, as an example it is assumed that the diameter of the through hole 125 of the magnet is 4.1 mm at the receiving portion 126. It should be understood that the distance is only an example and other sizes with similar relations to each other may be used in larger or smaller applications. The following example is an illustrative example showing the dimensional relationships between the through hole, the connection portion of the light guide and the protrusions. The diameter of the connection portion can be 4.06 mm which is thus smaller than the diameter of 4.1 mm of the through hole wherein the second protrusion 252 clearly has a larger diameter than the diameter of the through hole as shown in detail c of FIG. 8. The first protrusion 251 extends in a radial direction by for example 0.13 mm. The length of each of the first protrusions 251 in the longitudinal direction may be in a range of 0.5 to 3 mm, for example 1 mm. Below the first protrusion 251 the diameter may be 4.2 mm which is larger than the 4.06 mm of the connection portion and also larger than the diameter of the through hole. The light guide 200 can be inserted into the through hole from the front side with the inlet portion 240 being pushed through the through hole 125 until the first protrusion 251 abuts the lower edge of the pole piece 120. The second protrusion 252 is located such that it abuts on at the transition of the through hole where the receiving portion 126 transitions to the V-shaped portion 128.

The first and the second protrusions may be integrally formed with the light guide and are thus of the same material such as PMMA or PMMI or PC. The protrusions 251 can be dimensioned such that the protrusions may be deformed without being damaged when the light guide is inserted into the through hole.

As a result, a press fit or interference fit can be achieved. Particularly the interference fit provided by the protrusions 251 and 252 may be a press fit which can be assembled with cold pressing. As a consequence a reliable and secure fixing as well as an accurate positioning of the light guide 200 within the through hole can be achieved which avoids rattling sounds and does not limit the light guide sufficiency or its ability to effectively mix colors. Moreover, the design is sustainable and can easily be disassembled without damaging the material of the light guide or the drive unit.

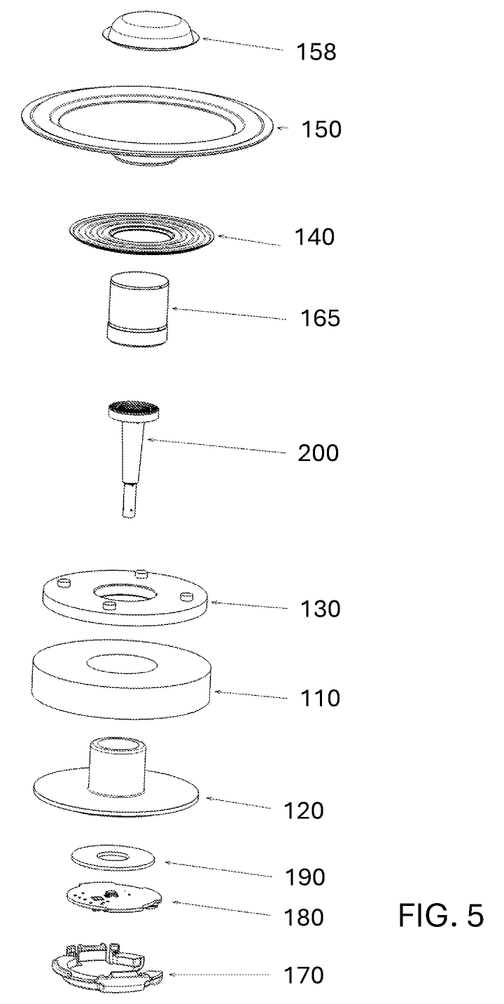

The arrangement of the different components of the speaker can also be deduced from the exploded view shown in FIG. 5. In the exploded view the protective cap 158 is shown followed by the diaphragm 150 and followed by the spider 140 which guides the movement of the diaphragm 150. Furthermore the voice coil 165 as shown, the light guide 200, and the drive unit including the pole piece 130, the magnet 110 and the pole piece 120. The circuit board 180 is connected to the pole piece 120 using the connecting element 190 which could be implemented as a double sided tape and the bracket 170 closes the speaker from behind.

FIG. 9 shows a further embodiment of a speaker 300 which is similar to the speaker 100 discussed above in connection with FIGS. 1 to 5. Speaker 300 is a woofer being configured to emit sound waves in a frequency range such as between 20 and 2000 Hz. The speaker comprises a drive unit with a first pole piece 320 , a second pole piece 330 and a magnet 310. Diaphragm 350 is connected via support 365 to a voice coil 360 and the movement is guided by a spider 340. Furthermore a cap 500 is provided. A light guide 400 with light exit 405 is provided and the light guide can correspond to light guide 200, but it is possible that other dimensions are used for the light guide 400. The light guide 400 is connected to the first pole piece in the same way as discussed in connection with FIGS. 1 to 8 in order to obtain the interference fit of the light guide to the first pole piece 320. However a larger gap can be provided between the drive unit and the spider and between the upper surface of the light guide 400 and cap 500 in order to allow larger excursions of the diaphragm 350 relative to the drive unit in order to make sure that the movement of the diaphragm is not influenced by the presence of the light guide. The gap between the drive unit and the spider 340 is larger compared to the embodiment explained in connection with FIGS. 1 to 8, as larger excursions of the diaphragm can occur. The gap between the drive unit and the spider can be in the range between 14 and 20 mm, preferably in the range between 16 and 17 mm. IN the same way the gap between the light guide and the cap 500 is larger as the cap moves together with the diaphragm 350. This gap can be in the same range, i.e. between 14 and 20 mm, preferably between 17 and 18 mm and thus slightly larger than the gap between the drive unit and the spider.

The aspects of the disclosure can be described by the following clauses:

Clause 1. A speaker configured to emit sound in a main sound emission direction, the speaker comprising a movable diaphragm; a drive unit comprising a magnet generating a magnetic field, a first pole piece comprising a through hole arranged to contact the magnet on a first surface of the magnet, a second pole piece arranged to contact the magnet on a second surface of the magnet opposite the first surface, wherein the first and second pole pieces are configured to generate a magnetic field in an air gap between the first and second pole piece where the diaphragm is located. The speaker includes a light source configured to emit light and a light guide configured to guide the light emitted by the light source through the through hole in direction of the main sound emission direction to the movable diaphragm, the light guide comprising an elongated first section with a longitudinal axis parallel to the main sound emission direction and a second section extending substantially perpendicular to the elongated first section, the light guide being configured to guide the light through the elongated first section to the second section where the light is guided in direction of the movable diaphragm, wherein the elongated first section comprises a first connecting element and a second connecting element to provide an interference fit between the light guide and the first pole piece.

Clause 2. The speaker of clause 1, wherein the through hole comprises a receiving portion extending in a direction parallel to the main sound emission direction hole, wherein the receiving portion, in direction of the main sound emission direction comprises a first end cooperating, for the interference fit, with the first connecting element and a second end cooperating with the second connecting element.

Clause 3. The speaker of clause 2, wherein a diameter of the receiving portion, in a direction perpendicular to the longitudinal axis, is substantially constant.

Clause 4. The speaker of any preceding clause, wherein the elongated first section of the light guide, comprises, following the main sound emission direction, an inlet portion configured to receive the light emitted by the light source, a connection portion comprising the first connecting element and the second connecting element, and a further portion by which the elongated first section is connected to the second section.

Clause 5. The speaker of clause 4, wherein the outlet portion has a trapezoidal shape where a diameter of the elongated first section perpendicular to the main sound emission direction increases towards the second section.

Clause 6. The speaker of clause 4 or 5, wherein the connection portion has a substantially cylindrical shape with a cylinder axis being parallel to the main sound emission direction.

Clause 7. The speaker of any preceding clause, wherein the first connecting element comprises a protrusion extending in a direction perpendicular from the elongated first section perpendicular to the longitudinal axis and cooperating with the first end of the through hole and the second connecting element comprises a second protrusion extending in a direction perpendicular from the light guide perpendicular to the longitudinal axis and cooperating with the second end of the through hole.

Clause 8. The speaker of any of clauses 2 to 7, wherein the first pole piece is formed such that at the through hole it comprises, following the main sound emission direction, a first conically shaped portion, followed by the connecting portion and followed by a second conically shaped portion, wherein the diameter of the first conically shaped portion increases in a direction opposite the main sound emission direction and the diameter of the second conically shaped portion in a direction of the main sound emission direction.

Clause 9. The speaker of any of clauses 4 to 8, wherein the connection portion has a cylindrical shape with the longitudinal axis of the connection portion extending parallel to the main sound emission direction.

Clause 10. The speaker of any preceding clause, further comprising a cap connected to the diaphragm, wherein the light guide is designed to guide the light emitted by the light source to the cap.

Clause 11. The speaker of any preceding clause, wherein the second section of the light guide is designed such that it does not include any connection to the drive unit.

Clause 12. The speaker of any preceding clause wherein the magnet is a ferrite magnet.

Clause 13. The speaker of any preceding clause, further comprising a circuit board and the light source is connected to the circuit board, a fixing element provided at the first pole piece, the fixing element fixedly connecting the circuit board to the first pole piece.

Summarizing, the audio speaker 100 discussed above provides an effective way for an illumination of the front surface of the diaphragm 150. Furthermore a compact volume is obtained and especially an effective connection of the light guide 200 to the other components of the light speaker. The speaker is also able to withstand the tough automotive requirements.

What is claimed is:

1. A speaker configured to emit sound in a main sound emission direction, the speaker comprising:
a movable diaphragm;
a drive unit comprising:
a magnet generating a magnetic field,
a first pole piece comprising a through hole arranged to contact the magnet on a first surface of the magnet,
a second pole piece arranged to contact the magnet on a second surface of the magnet opposite the first surface, wherein the first and second pole pieces are configured to generate a magnetic field in an air gap between the first and second pole piece where the diaphragm is located;
a light source configured to emit light;
a light guide configured to guide the light emitted by the light source through the through hole in direction of the main sound emission direction to the movable diaphragm, the light guide comprising an elongated first section with a longitudinal axis parallel to the main sound emission direction and a second section extending substantially perpendicular to the elongated first section, the light guide being configured to guide the light through the elongated first section to the second section where the light is guided in direction of the movable diaphragm, wherein the elongated first section comprises a first connecting element and a second connecting element to provide an interference fit between the light guide and the first pole piece.

2. The speaker of claim 1, wherein the through hole comprises a receiving portion extending in a direction parallel to the main sound emission direction, wherein the receiving portion, in direction of the main sound emission direction comprises a first end cooperating, for the interference fit, with the first connecting element and a second end cooperating with the second connecting element.

3. The speaker of claim 2, wherein a diameter of the receiving portion, in a direction perpendicular to the longitudinal axis, is substantially constant.

4. The speaker of claim 1, wherein the elongated first section of the light guide, comprises, following the main sound emission direction, an inlet portion configured to receive the light emitted by the light source, a connection portion comprising the first connecting element and the second connecting element, and a further portion by which the elongated first section is connected to the second section.

5. The speaker of claim 4, wherein the outlet portion has a trapezoidal shape where a diameter of the elongated first section perpendicular to the main sound emission direction increases towards the second section.

6. The speaker of claim 4, wherein the connection portion has a substantially cylindrical shape with a cylinder axis being parallel to the main sound emission direction.

7. The speaker of claim 1, wherein the first connecting element comprises a protrusion extending in a direction perpendicular from the elongated first section perpendicular to the longitudinal axis and cooperating with the first end of the through hole and the second connecting element comprises a second protrusion extending in a direction perpendicular from the light guide perpendicular to the longitudinal axis and cooperating with the second end of the through hole.

8. The speaker of claim 2, wherein the first pole piece is formed such that at the through hole it comprises, following the main sound emission direction, a first conically shaped portion, followed by the connecting portion and followed by a second conically shaped portion, wherein the diameter of the first conically shaped portion increases in a direction opposite the main sound emission direction and the diameter of the second conically shaped portion in a direction of the main sound emission direction.

9. The speaker of claim 4, wherein the connection portion has a cylindrical shape with the longitudinal axis of the connection portion extending parallel to the main sound emission direction.

10. The speaker of claim 1, further comprising a cap connected to the diaphragm, wherein the light guide is designed to guide the light emitted by the light source to the cap.

11. The speaker of claim 1, wherein the second section of the light guide is designed such that it does not include any connection to the drive unit.

12. The speaker of claim 1, wherein the magnet is a ferrite magnet.

13. The speaker of claim 1, further comprising:
a circuit board and the light source is connected to the circuit board,
a fixing element provided at the first pole piece, the fixing element fixedly connecting the circuit board to the first pole piece.
